(19) United States
(12) Patent Application Publication
(10) Pub. No.: US 2025/0326910 A1
(43) Pub. Date: Oct. 23, 2025

(54) METHOD FOR PRODUCING SURFACE-MODIFIED MICRO-FIBRILLATED CELLULOSE

(71) Applicants: Dätwyler Schweiz AG, Schattdorf (CH); EMPA Eidgenössische Materialprüfungs- und Forschungsanstalt, Dübendorf (CH)

(72) Inventors: Ming LIU, Dübendorf (CH); Luana LETTIERI, Luzern (CH); Mattia Alberto LUCCHINI, Luzern (CH); Gustav NYSTRÖM, Windisch (CH); Thomas GEIGER, Dübendorf (CH)

(73) Assignees: Dätwyler Schweiz AG, Schattdorf (CH); EMPA Eidgenössische Materialprüfungs- und Forschungsanstalt, Dübendorf (CH)

(21) Appl. No.: 18/868,944

(22) PCT Filed: May 12, 2023
(86) PCT No.: PCT/CH2023/050015

§ 371 Date: Nov. 25, 2024

(30) Foreign Application Priority Data
May 25, 2022 (CH) 000628/2022

(51) Int. Cl. C08J 9/28; C08K 5/00; C08K 5/5425

(52) U.S. Cl. CPC C08J 9/28; C08K 5/0016; C08K 5/5425; C08J 2301/02

(57) ABSTRACT

A method for producing hydrophobic dry surface-modified fibrillated cellulose to improve dispersion in hydrophobic matrices includes: providing micro-fibrillated cellulose suspension of 5-30 wt % in water; adding a surfactant to the suspension with a mass ratio of surfactant to micro-fibrillated cellulose suspension of 0.1-2.0 wt %; adding a surface modifier to the suspension with a mass ratio of surface modifier to micro-fibrillated cellulose dry matter of 20-300 wt %, with the surface modifier obtained through a chemical reaction of a silane compound with a phenolic compound to create covalent bonds between the silane compound and the phenolic compound; covalently binding the surface modifier to the micro-fibrillated cellulose via (i) hydrolysis of the surface modifier to form reactive silanol groups and (ii) condensation of the silanol groups with available OH-groups of the micro-fibrillated cellulose; adding a plasticizer to the suspension of surface modified micro-fibrillated cellulose; drying the suspension.

### TECHNICAL FIELD

The invention relates to a method of producing hydrophobic dry surface-modified fibrillated cellulose to improve its dispersion in hydrophobic matrices.

### TECHNICAL BACKGROUND

As commonly known, wood is built up by a cellulose matrix. The fibers that form such a matrix are fibril bundles which in turn consist of small elements, caged microfibrils. From a chemical perspective, cellulose is a polymer put together from Cellobiose monomers. Cellobiose monomers again, are built up by two β-1,4-glycosidic bound glucose molecules (disaccharide). Through a fibrillation process the cellulose fibers are separated from their source materials (e.g. wood, grass, and agricultural residues) into a three-dimensional network of microfibrils with a large surface area. These entangled fibrils are called “micro-fibrillated cellulose” (MFC). The micro-fibrillated cellulose (MFC) may be further processed to even thinner nano-fibrillated cellulose (NFC).

Substrates based on cellulose, such as cellulose fibres or fibrillated cellulose, are used with increasing interest as filler materials for different composite materials, because of availability, natural resources, but also excellent mechanical properties.

However, there are two main challenges in incorporating nanocellulose into hydrophobic materials: (1) Removal of water within the native cellulosic materials, which proves to be difficult due to the strong hydrophilic nature of cellulose and the tendency of such material to aggregate and/or hornificate irreversibly during water removal and/or drying; and (2) low compatibility between hydrophilic cellulose substrates and a hydrophobic matrix.

To prevent or reduce irreversible aggregation, time- and energy-intensive drying processes, such as freeze drying, supercritical drying, and/or solvent exchange drying, are usually used. Those processes due to high energy/time and/or organic solvents consumption are usually only used at laboratory scales, is not economical for commercial production of nanocellulose. To improve compatibility, cellulose substrates can be subjected to various surface modifications to increase the hydrophobicity of the cellulosic material. The surface of the nanocellulose may be modified by esterification, acetylation acylation, molecular and/or polymer grafting, urethanization. (References: (1) Habibi Youssef (2014). Key advances in the chemical modification of nanocellulose. Chem. Soc. Rev. 2014, 43, 1519 DOI: 10.1039/C3CS60204D. (2) Eyley Samuel and Thielemans Wim (2014). Surface modification of cellulose nanocrystals. Nanoscale, 2014, 6, 7764-7779.)

Most of those reactions are sensitive to moisture and water, therefore the reactions need to be carried out in organic solvents without presence of water. This requires removal of water from the cellulosic substrates prior to surface modification, which faces the same challenge as described before (1).

To avoid of water removal and pre-drying cellulose fibers prior to surface modification, the following methods are usually applied: (i) non-covalent surface modification (e.g. coating method) or (ii) chemical reactions that are tolerant with water (e.g. silylation); or (lii) a combination of (i) and (ii).

WO2020086419 describes a method to prepare nanocellulose masterbatch with improved nanocellulose dispersion in elastomeric compounds. The method uses a partitioning agent containing carbon black, an elastomer latex, a wax as compatibilizers forming non-covalent bonds with nanocellulose. These compositions can avoid cellulose aggregation upon drying in the masterbatch preparation.

WO2021070899 describes a method to prepare nanocellulose masterbatch using surfactant and resorcinol-formaldehyde oligomer, and formaldehyde, and a rubber latex. The surfactant and resorcinol-formaldehyde resin acting as compatibilizers improve nanocellulose dispersion in the rubber latex.

The drawbacks of using nanocellulose masterbatches prepared through above-mentioned methods for the end applications are (1) low compatibility with different rubber recipes for various end applications; (2) potentially increase the cost of the filler (e.g. extra processing, transportation, and storage); (3) low improvement in the mechanical properties of rubber compounds without present cross-linkable functional groups on the surface of cellulose.

Instead, some other efforts were made to address those drawbacks by avoid using latex and/or by grafting a modifier onto the surface of cellulose. The modifiers are desired to possess at least two types of functional groups, one of which reacts with hydroxyl groups of cellulose forming covalent bonds, and the other can create covalent linkages with elastomer matrices during rubber curing process.

WO2020142793 describes improved compositions and methods for dispersion and drying of nanocellulose, for polymer composites. The disclosed nanocellulose-dispersion concentrate comprises nanocellulose and with the nanocellulose-containing composite product, wherein the dispersion/drying agent is selected from the group consisting of waxes, polyolefins, olefinmaleic anhydride copolymers, olefinacrylic acid copolymers, polyols, fatty acids, fatty alcohols, polyglyceride esters, polydimethylsiloxanes, polydimethylsiloxanealkyl esters, polyacrylamides, starches, cellulose derivatives, particulates, and combinations or reaction products thereof.

WO2017219145 describes a method to prepare hydrophobic cellulosic materials using a modified styrene-co-maleic anhydride in aqueous solution. The anhydride groups could potentially react with both cellulose and water in the solvent. After reacting with cellulose, covalent ester bonds could form. After reacting with water, the copolymer can act as coating polymer onto the surface of cellulose. The functional groups of styrene could further form linkages with rubber polymers during rubber curing process.

### SUMMARY OF THE INVENTION

It is an objective of the invention to provide an alternative method for producing hydrophobic dry surface-modified fibrillated cellulose to improve its dispersion in hydrophobic matrices. Another objective is to provide a method that is applicable to high concentrated fibrillated cellulose paste. Another objective is to provide a method that avoids the consumption of organic solvents and to avoid (toxic) waste produced in the entire process.

At least one of the objectives of the present invention is achieved by a method according to claim 1. The method for producing hydrophobic dry surface-modified fibrillated cellulose to improve its dispersion in hydrophobic matrices comprising the steps of: a.) providing micro-fibrillated cellulose suspension of 5 to 30 wt % in water, preferably approx. 7 to 11 wt %; b.) adding a surfactant to the suspension with a mass ratio of surfactant to micro-fibrillated cellulose suspension of 0.1 to 2.0 wt %, preferably 0.5 to 1.0 wt %, more preferably about 0.8 wt %; c.) adding a surface modifier to the suspension with a mass ratio of surface modifier to micro-fibrillated cellulose dry matter of 20 to 300 wt %, preferably 80 to 120 wt %, more preferably approx. 100 wt %, wherein the surface modifier is obtained through a chemical reaction of a silane compound with a phenolic compound to create covalent bonds between the silane compound and the phenolic compound; d.) covalently binding the surface modifier to the micro-fibrillated cellulose via (i) hydrolysis of the surface modifier to form reactive silanol groups (R—Si—OH) and (ii) condensation of the silanol groups of the surface modifier with the available OH-groups of the micro-fibrillated cellulose, e.) adding a plasticizer to the suspension of surface modified micro-fibrillated cellulose; f.) drying the suspension to remove water and obtain the dry powder of surface-modified micro-fibrillated cellulose.

The product of the method is a dry powder of hydrophobic surface-modified fibrillated cellulose, which is suitable as filler materials for different composite materials, where a matrix material of the composite material is also hydrophobic.

In the context of the present invention the term “dry powder” is understood as a final compound of surface-modified micro-fibrillated cellulose with a water content below 10 wt %, preferably 5 wt % (residual humidity present in the product). As the final compound comprises surfactant, surface modifier and plasticizer such that the final compound may be more of a powdery-like material.

The method avoids the consumption of organic solvents and thereby also avoids (toxic) waste produced due to the solvents. Furthermore, the method is directly applicable to paste-like concentrated fibrillated cellulose in water without using solvents.

It also has a high scalability to produce a large quantity of surface-modified micro-fibrillated cellulose.

It also allows to use conventional drying methods and facilities to produce the dry powder of surface-modified micro-fibrillated cellulose. The conventional drying techniques can include, but are not limited to, evaporation, spray drying, spin-flask drying, high-shear mixing and drying, drum drying.

Further embodiments of the invention are set forth in the dependent claims.

In some embodiments the hydrolysis and a partial condensation may be performed at 20 to 120° C., preferably at approx. 120° C., during at least 5 minutes and up to 4 hours, preferably approx. 2 hours.

In some embodiments drying and further condensation may be performed at 20 to 130° C., preferably at approx. 60° C. Good results have been achieved with approx. 60° for approx. 24 hours.

In some embodiments drying and further condensation may be performed at a pressure of a pressure of 5 mbar to 1000 mbar.

In some embodiments drying and further condensation may be performed until a dry powder with a moisture content below 10 wt %, preferably below 5 wt %, is obtained.

In some embodiments the fibrillated cellulose may be nano-fibrillated cellulose with particle length in the range of 1 to 500 nm or micro-fibrillated cellulose with particle length in the range of 100 nm to 500 μm and/or fibrils of the micro-fibrillated cellulose may have a diameter in the range of 1 nm to 100 nm.

In some embodiments wherein the silane compound may comprise a functional group of at least a primary or a secondary amine group, and may be selected from the group of 3-aminopropyltriethoxysilane, 3-aminopropyltrimethoxysilane, 3-aminopropyldimethylethoxy-silane, 1-amino-2-(dimethylethoxysilyl)propane, 3-aminopropyldiisopropylethoxysilane, (Aminoethylaminomethyl)phenethyltnmethoxysilane, N-(2-Aminoethyl)-11-aminoundecyl-trimethoxysilane, 3-(N-allylamino)propyltrimethoxysilane, N-butylaminopropyltrimethoxy-silane, t-Butylaminopropyltrimethoxysilane, (N-cyclohexylaminomethyl)methyldiethoxy-silane, (N-Cyclohexylaminomethyl)triethoxysilane, (N-Cyclohexylaminopropyl)trimethoxy-silane, (3-(N-ethylamino)isobutyl)methyldlethoxysilane, N-methylaminopropylmethyl-dimethoxysilane, N-methylaminopropyltrimethoxysilane, (Phenylaminomethyl)methyl-dimethoxysilane, N-phenylaminomethyltrethoxysilane, N-phenylaminopropyltrimethoxy-silane and combinations thereof. Good results have been achieved at least with 3-aminopropyltriethoxysilane (APTES).

In some embodiments the phenolic compound may have the common structure of

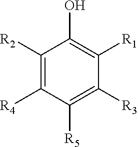

wherein at least one of the substituents R1 and R1 at the ortho positions of the —OH group is hydrogen H; wherein at least one of the other substituents either at the meta positions R3 and R4 or at the para position R5 of the —OH group comprises a hydrocarbon backbone in the range of C2 to C30, preferably comprising at least one unsaturated pi bond. The hydrocarbon backbone may comprise a halogen, or nitrogen, or sulfur and/or functional groups selected from thiol, epoxide, disulfide, polysulfide, amines, ketone, hydroxyl, carboxylic acid, amine and ketone.

In some embodiments the phenolic compound may be selected from the group of cardanol, eugenol, anacardol, campnospermanol, promalabaricones, elenic acid, plakinidone, anacardic acid, anagigantic acid, pelandiauic acid, ginkgolic acid, frutesins, microphyllinic acid, merulinic acid, urushiol, bhilavanol, renghol, thitsiol, laccol, urushiol, glutarenghol, gingerol, shogaol, zingerone and combinations thereof. Good results have been achieved at least with cardanol.

In some embodiments the surfactant may be selected from the group of docusate sodium or silicone-containing surfactant, polyoxyethylenesorbitan monolaurate; polyethylene glycol sorbitan monolaurate, octylphenol ethoxylate, polyethylene sorbitol ester, sodium dodecyl sulfate and combinations thereof.

In some embodiments the plasticizer is selected from the group of mineral oil, butylcarbitoladipate, ether thioether aromatic extracts and combinations thereof. Good results have been achieved at least with mineral oil.

In some embodiments the mole ratio between the silane compound and the phenolic compound may be in the range of 0.5:1 and 2:1.

In some embodiments the plasticizer may be added with a mass ratio of plasticizer to micro-fibrillated cellulose dry matter of 10 to 200 wt %, preferably 50 to 150 wt %.

In some embodiments no other solvents than water is used, i.e. the method can be performed without the use of e g. organic solvents.

The invention further relates to the use of dry surface-modified fibrillated cellulose produced according to above method as a reinforcing filler for polymeric materials.

### BRIEF EXPLANATION OF THE FIGURES

The invention is described in greater detail below with reference to embodiments that are illustrated in the figures. The FIGURES show:

FIG. 1 Graph of stress (N/mm2) versus elongation (%) of examples.

### EMBODIMENTS OF THE INVENTION

### Example APTES-Cardanol Modified MFC Filler

Lab scale synthesis involved surface modification of a water suspension of two different sources for MFCs. The modification consists in making the surface properties of MFCs hydrophobic through chemical reaction with a mixture of APTES (3-aminopropyltriethoxysilane) and cardanol (phenolic lipid) using surfactant and mineral oil as reaction media. The mixture is then dried to obtain the final product.

| Step | Compound | Amount (g) | mixing order |
|---|---|---|---|
| 1 | MFC (7-11 wt % in water) | 2500.0 | 1 |
| 2 | surfactant | 20.8 | 2 |
| 3 | APTES-Cardanol | 250.0 | 3 |
| 4 | Mineral oil | 125 | 4 |

Conditions for synthesis of surface modifier APTES-Cardanol: 167 g Cardanol (560 mmol), 123.8 g APTES (560 mmol), 33.6 g paraformaldehyde (1.12 moo). Reaction at 65° C., 6 hours.

Reaction conditions: (1) Mixing MFC with surfactant at room temperature, 1000 rpm for 30 min.; (2) addition and mixing of APTES-Cardanol; (3) hydrolysis and partial condensation at approx. 120° C. during approx. 2 hours; (4) addition of mineral oil as plasticizer and (5) drying in an oven at 60° C. for 48 hours, wherein further condensation takes place.

### Proof of Concept:

Dried modified MFC of the above reaction were compounded within an EPDM (ethylene propylene diene monomer) matrix. The compound was subsequently vulcanized. Properties have been compared to vulcanized compounds without and reinforced with synthetic aramid fibres instead of modified MFC.

| | | | Reference | Sample A | Sample B |
|---|---|---|---|---|---|
| Charac- | | Test | (no fibers/ | (aramid | (modified |
| teristics | Unit | method | MFC) | fibres) | MFC) |
| Specific | g/cm3 | DIN53479 | 1.05 | 1.12 | 1.13 |
| Weight | | | | | |
| Hardness | ShA | DIN53505 | 63 | 86 | 83 |
| Micro | IRHD | DIN53519 | 61 | 80 | 80 |
| Hardness | | | | | |
| Tensile | N/mm2 | DIN53504 | 11.9 | 8.3 | 11.3 |
| Strength | | | | | |
| Elongation | % | DIN53505 | 285 | 183 | 204 |
| at Break | | | | | |
| M 50 | N/mm2 | DIN53505 | 1.5 | 7.8 | 7.1 |
| M 100 | N/mm2 | DIN53505 | 3.1 | 7.9 | 8.5 |
| M 200 | N/mm2 | DIN53504 | 7.3 | — | 11.2 |
| Tear | N/mm | DIN53507 | 2.6/2.7/2.9 | 11.6/10.4/10.2 | 7.6/7.4/7.1 |
| Resistance | | | | | |

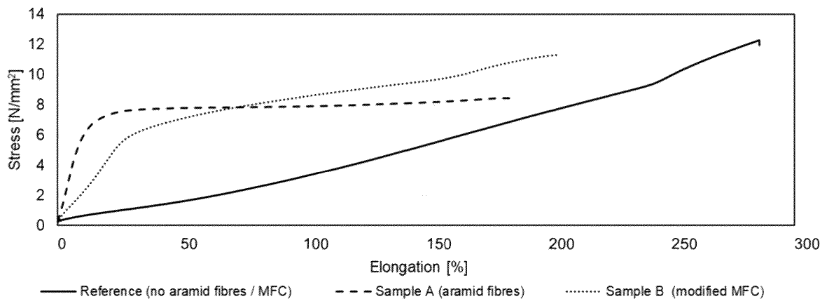

FIG. 1 shows a graph of stress (N/mm2) versus elongation (%) of the different compounds.

The modified MFC showed a good stability, dispersibility and processability within the hydrophobic elastomeric matrix (here: EPDM). Physical and mechanical properties resulted were improved compared to control compounds (without MFC or aramid fibres and reinforced with synthetic aramid fibres).

1. A method for producing hydrophobic dry surface-modified fibrillated cellulose to improve dispersion in hydrophobic matrices the method comprising:
a. providing micro-fibrillated cellulose suspension of 5 to 30 wt % in water;
b. adding a surfactant to the suspension with a mass ratio of surfactant to micro-fibrillated cellulose suspension of 0.1 to 2.0 wt %;
c. adding a surface modifier to the suspension with a mass ratio of surface modifier to micro-fibrillated cellulose dry matter of 20 to 300 wt %, wherein the surface modifier is obtained through a chemical reaction of a silane compound with a phenolic compound to create covalent bonds between the silane compound and the phenolic compound;
d. covalently binding the surface modifier to the micro-fibrillated cellulose via (i) hydrolysis of the surface modifier to form reactive silanol groups (R—Si—OH) and (ii) condensation of the silanol groups of the surface modifier with the available OH-groups of the micro-fibrillated cellulose,
e. adding a plasticizer to the suspension of surface modified micro-fibrillated cellulose;
f. drying the suspension to remove water and obtain a dry powder of surface-modified micro-fibrillated cellulose.

2. The method according to claim 1, wherein the hydrolysis and partial condensation is performed at 20 to 120° C. during at least 5 minutes and up to 4 hours.

3. The method according to claim 1, wherein drying and further condensation is performed at 20 to 130° C. and/or at a pressure of 5 mbar to 1000 mbar.

4. The method according to claim 1, wherein drying and further condensation is performed until a dry powder with a moisture content below 10 wt % is obtained.

5. The method according to claim 1, wherein the micro-fibrillated cellulose has a particle length in the range of 100 nm to 500 μm and/or fibrils of the micro-fibrillated cellulose have a diameter in the range of 1 nm-100 nm.

6. The method according to claim 1, wherein the silane compound comprises a functional group of at least a primary or a secondary amine group, and is selected from the group of 3-aminopropyltriethoxysilane, 3-aminopropyltrimethoxysilane, 3-aminopropyldimethylethoxysilane, 1-amino-2-(dimethylethoxysilyl)propane, 3-aminopropyldiisopropylethoxysilane, (Aminoethylaminomethyl)phenethyltrimethoxysilane, N-(2-Aminoethyl)-11-aminoundecyltrimethoxysilane, 3-(N-allylamino)propyltrimethoxysilane, N-butylaminopropyltrimethoxysilane, t-Butylaminopropyltrimethoxysilane, (N-cyclohexylaminomethyl)methyldiethoxysilane, (N-Cyclohexylaminomethyl)triethoxysilane, (N-Cyclohexylaminopropyl)trimethoxysilane, (3-(N-ethylamino)isobutyl)methyldiethoxysilane, N-methylaminopropylmethyldimethoxysilane, N-methylaminopropyltrimethoxysilane, (Phenylaminomethyl)methyldimethoxysilane, N-phenylaminomethyltriethoxysilane, N-phenylaminopropyltrimethoxysilane and combinations thereof.

7. The method according to claim 1, wherein the phenolic compound has the common structure of 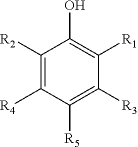
wherein at least one of the substituents R1 and R1 at the ortho positions of the —OH group is hydrogen H;
wherein at least one of the other substituents either at the meta positions R3 and R4 or at the para position R5 of the —OH group comprises a hydrocarbon backbone in the range of C2 to C30.

8. The method according to claim 7, wherein the hydrocarbon backbone comprises a halogen, or nitrogen, or sulfur and/or functional groups selected from thiol, epoxide, disulfide, polysulfide, amines, ketone, hydroxyl, carboxylic acid, amine and ketone.

9. The method according to claim 1, wherein the phenolic compound is selected from the group of cardanol, eugenol, anacardol, campnospermanol, promalabaricones, elenic acid, plakinidone, anacardic acid, anagigantic acid, pelandiauic acid, ginkgolic acid, frutesins, microphyllinic acid, merulinic acid, urushiol, bhilavanol, renghol, thitsiol, laccol, urushiol, glutarenghol, gingerol, shogaol, zingerone and combinations thereof.

10. The method according to claim 1, wherein the mole ratio between the silane compound and the phenolic compound is in the range of 0.5:1 and 2:1.

11. The method according to claim 1, wherein the surfactant is selected from the group of docusate sodium or silicone-containing surfactant, polyoxyethylenesorbitan monolaurate; polyethylene glycol sorbitan monolaurate, octylphenol ethoxylate, polyethylene sorbitol ester, sodium dodecyl sulfate and combinations thereof.

12. The method according to claim 1, wherein the plasticizer is selected from the group of mineral oil, butylcarbitoladipate, ether thioether aromatic extracts and combinations thereof.

13. The method according to claim 1, wherein the plasticizer is added with a mass ration of plasticizer to micro-fibrillated cellulose dry matter of 10 to 200 wt %.

14. The method according to claim 1, wherein no other solvents than water are used.

15. (canceled)

16. The method according to claim 1, wherein the micro-fibrillated cellulose suspension of step a is 7 to 11 wt % in water.

17. The method according to claim 1, wherein the mass ratio of surfactant to micro-fibrillated cellulose suspension of step b is 0.5 to 1.0 wt %.

18. The method according to claim 1, wherein the mass ratio of surface modifier to micro-fibrillated cellulose dry matter of step c is 80 to 120 wt %.
